(19) United States
(12) Patent Application Publication
(10) Pub. No.: US 2003/0127770 A1
(43) Pub. Date: Jul. 10, 2003

(54) Low birefringence, low stress film suitable for optical applications

(75) Inventors: Kang Xi, Terre Haute, IN (US); Safwat Tadros, Evansville, IN (US)

Correspondence Address: Robert E. Walter, GE Plastics, One Plastics Avenue, Pittsfield, MA, 01201, US

(73) Assignee: General Electric Company

(21) Appl. No.: 10/309,973

(22) Filed: Dec. 4, 2002

Related U.S. Application Data
(60) Provisional application No. 60/344,265, filed on Dec. 27, 2001.

(51) Int. Cl. B29C 47/00

(52) U.S. Cl. 264/175; 264/210.1

(57) ABSTRACT

A process for producing a polycarbonate film suitable for optical media applications having a birefringence of less than about 50 nm and low stress wherein the polycarbonate has a weight average molecular weight of about 30,000 or less and preferably 13,000 to about 25,000, extruding the polycarbonate film at a temperature of about 275° C. to about 360° C., the polycarbonate has a melt viscosity of about 100 to about 275 Pascal and a thickness of about 100 to about 600 μm, advancing the melted polymer film into a gap between two calendering rolls which calendaring rolls are at a temperature below the glass transition temperature, advancing the melted polycarbonate film through the gap and cooling the polycarbonate film wherein the polycarbonate film is extruded at the rate of about 10 to 100 feet per minute; and to a polycarbonate film prepared by the process above described.

### CROSS-REFERENCE TO RELATED APPLICATIONS

This application is related to and claims priority from Provisional Application No. 60/344,265 filed on Dec. 27, 2001, the entire contents of which are incorporated

### FIELD OF INVENTION

This invention relates to polycarbonate resins suitable for use in optical applications and methods for making polycarbonate resin articles in the form of film particularly for optical discs such as CD's (Compact Discs), CD-ROM, DVD (Digital Versatile Discs), and the like wherein the resin articles have low birefringence and low residual stress.

### BACKGROUND OF THE INVENTION

Currently polycarbonate is used as the polymeric material for producing such optical media applications and are made by injection molding. The process is relatively slow and expensive with one injection molding machine typically producing 1 or 2 discs every 3-5 seconds. While this seems relatively fast, it is actually slow and expensive. In addition, it is difficult to produce discs in the future with very low birefringence which will be required to reach higher data densities. Stress and thus birefringence is inherent in injection molding because the melt is solidifying on the walls as the mold is filled, and then additional material is forced into the cavity to compensate for shrinkage as the disc solidifies.

Birefringence is defined as the difference between the refractive indices along two perpendicular directions as measured with polarized light along these directions. It results from molecular orientation, and the measurement of birefringence is the most common method of characterizing polymer orientation. It is determined by measurement of the retardation distance by either a compensation or a transmission method. Positive birefringence results when the principal optic axis lies along the chain; negative birefringence when transverse to the chain. In cartesian coordinates there are three birefringences, two being independent. Thus Δxy=nₓ−n_{y}, the differences in refractive indices along the x and y axes. Uniaxial orientation only requires one of these to describe the orientation. Therefore, in order to obtain a uniform homogeneous polycarbonate, the lower the birefringence (the differences between the refractive indices) the more homogeneous the polymer composition of the product and thus the more uniform properties of the product. This is critical, particular in CD's, DVD's or LCD wherein the laser read out must have minimal or zero distortion. The lower birefringence, the less is the variation in polymer homogeneity and laser distortion.

Improvements in optical data storage media, including increased data storage density, are highly desirable, and achievement of such improvements is expected to improve well established and new computer technology such as read only ROM, write once, rewritable, digital versatile and magneto-optical (MO) disks.

In the case of CD-ROM technology, the information to be read is imprinted directly into a moldable, transparent plastic material, such as bisphenol A (BPA) polycarbonate. The information is stored in the form of shallow pits embossed in a polymer surface. The surface is coated with a reflective metallic film, and the digital information, represented by the position and length of the pits, is read optically with a focused low power (5 mW) laser beam. The user can only extract information (digital data) from the disk without changing or adding any data. Thus, it is possible to “read” but not to “write” or “erase” information.

The operating principle is a write once read many (WORM) drive is to use a focused laser beam (20-40 mW) to make a permanent mark on a thin film on a disk. The information is then read out as a change in the optical properties of the disk, e.g., reflectivity or absorbance. These changes can take various forms such as, “hole burning” which is the removal of material, typically a thin film of tellurium, by evaporation, melting or spalling (sometimes referred to as laser ablation), or bubble, or pit formation involves deformation of the surface, usually of a polymer overcoat of a metal reflector.

Although the CD-ROM and WORM formats have been successfully developed and are well suited for particular applications, the computer industry is focusing on erasable media for optical storage (EODs). There are two types of EODs: phase change (PC) and magneto-optic (MO).

Generally, amorphous materials are used for MO storage and have a distinct advantage in MO storage, as they do not suffer from “grain noise”, spurious variations in the plane of polarization of reflected light caused by randomness in the orientation of grains in a polycrystalline film. Bits are written by heating above the Curie point, T_{c}, and cooling in the presence of a magnetic field, a process known as thermomagnetic writing. In the phase-change material, information is stored in regions that are different phases, typically amorphous and crystalline. The film is initially crystallized by heating it above the crystallization temperature. In most of these materials, the crystallization temperature is close to the glass transition temperature. When the film is heated with a short, high power focused laser pulse, the film can be melted and quenched to the amorphous state. The amorphized spot can represent a digital “1” or a bit of information. The information is read by scanning it with the same laser, set at a lower power, and monitoring the reflectivity.

In the case of WORM and EOD technology, the recording layer is separated from the environment by a transparent, non-interfering shielding layer. Materials selected for such “read through” optical data storage applications must have outstanding physical properties, such as moldability, ductility, a level of robustness compatible with particular use, resistance to deformation when exposed to high heat or high humidity, either alone or in combination. The materials should also interfere minimally with the passage of laser light through the medium when information is being retrieved from or added to the storage device.

As data storage densities are increased in optical data storage media to accommodate newer technologies, such as DVD and higher density data disks for short or long term data archives, the design requirements for the transparent plastic component of the optical data storage devices have become increasingly stringent. Materials displaying lower birefringence at current, and in the future progressively shorter “reading and writing” wavelengths have been the object of intense efforts in the field of optical data storage devices.

Birefringence in an article molded from polymeric material is related to orientation and deformation of its constituent polymer chains. Birefringence has several sources, including the structure and physical properties of the polymer material, the degree of molecular orientation in the polymer material and thermal stresses in the processed polymer material. For example, the birefringence of a molded optical article is determined, in part, by the molecular structure of its constituent polymer and the processing conditions, such as the forces applied during mold filling and cooling, used in its fabrication which can create thermal stresses and orientation of the polymer chains.

The observed birefringence of a disk is therefore determined by the molecular structure, which determines the intrinsic birefringence, and the processing conditions, which can create thermal stresses and orientation of the polymer chains. Specifically, the observed birefringence is typically a function of the intrinsic birefringence and the birefringence introduced upon molding articles, such as optical disks. The observed birefringence of an optical disk is typically quantified using a measurement termed “in-plane birefringence” or IBR, which is described more fully below.

For a molded optical disk, the IBR is defined as:

IBR=(nᵣ−n_{θ})d=Δn_{rθ}d(3)

where nᵣ and n_{θ} are the refractive indices along the r and θ cylindrical axes of the disk; nᵣ is the index of refraction seen by a light beam polarized along the radial direction, and n_{θ} is the index of refraction for light polarized azimuthally to the plane of the disk. The thickness of the disk is given by d. The IBR governs the defocusing margin, and reduction of IBR will lead to the alleviation of problems which are not correctable mechanically. IBR is a property of the finished optical disk. It is formally called a “retardation” and has units of nanometers.

In applications requiring higher storage density, such as DVD recordable and rewritable material, the properties of low birefringence and low water absorption in the polymer material from which the optical article is fabricated become even more critical. In order to achieve higher data storage density, low birefringence is necessary so as to minimally interfere with the laser beam as it passes through the optical article, for example a compact disk.

Materials for DVD recordable and rewritable material require low in-plane birefringence, in particular preferably less than about +/−40 nm single pass; excellent replication of the grooved structure, in particular greater than about 90% of stamper.

The great economic advantage of producing optical media at a faster rate via a continuous film extrusion process whereby a continuous plastic film or sheet of 4-8 feet wide could be produced at speeds of 10-60 feet/minute from which discs could be cut out is certainly desired. Extrusion casting, where a melt is extruded through a slot die and deposited on a polished metal roller to solidify, can produce low birefringence film but the top surface of the film is not smooth enough. Extrusion calendering, whereby a second polished metal roll is added to form a nip or gap to squeeze the plastic on both sides as it solidifies, is widely used to produce very uniform and smooth surface films, but the flow in the nip between rigid rolls induces very high stresses and such films have retardation values of hundreds to thousands of nanometers. A resilient elastomeric cover can be put on one of the rolls to produce textured films that have lower stress, but the texture is unacceptable for optical media applications.

U.S. Pat. No. 3,756,760 teaches the use of a single metal outer sleeve of nickel over a rubber-covered roller to accommodate and smooth the non-uniformity of the extrudate from an extrusion die upon delivering melt to the calendering nip. It does not disclose how to use this to control stress in the film and birefringence. In addition, such a sleeve is too fragile to be of practical use.

U.S. Pat. No. 5,076,987 discloses producing optical quality extrusion film by calendering the film between a ground elastic roller and a high gloss steel roller or between a lacquered elastic roller and a high gloss steel roller or between a ground elastic roller and a high gloss steel roller to produce a film having a high gloss surface and a matte surface or coating the matte surface, or producing a film having a high gloss on both surfaces.

U.S. Pat. No. 5,149,481 discloses extruding a sheet or film into the roll gap of a smoothed upper roll and a lower roll wherein the temperature of the upper roll is below the glass transition temperature of the plastic and the lower roll is maintained at a temperature in the plastic state domain of the plastic sheet or film.

U.S. Pat. No. 5,242,742 is similar to U.S. Pat. No. 5,149,481 except that it discloses a sheet of film having a birefringence of less than 50 nm and preferably less than 20 nm, wherein one surface is cooled to below the glass transition temperature while the other surface is maintained in the thermoplastic state.

U.S. Pat. No. 4,925,379 discloses a process for producing a plastic sheet, wherein at least one layer is a polyurethane layer, by extrusion and pressing at a temperature higher than the softening point of the polyurethane.

U.S. Pat. No. 5,286,436 is a division of U.S. Pat. No. 5,242,742 and discloses producing a thermoplastic strip having a birefringence equal to or less than 50 nm, wherein one surface is cooled to below the glass transition temperature and the other surface is maintained in the thermoplastic state and then cooling the thermoplastic strip.

It has been surprisingly discovered that homo-polycarbonate film can be prepared quickly and economically by extruding molten polycarbonate resin having a low viscosity into the nip or gap between highly polished chrome-surfaced rolls wherein the temperature of the rolls are maintained at below the glass transition temperature (Tg) of the polycarbonate film preferably about 110° C. to about 130° C. and the rate of the film through the rolls is about 10 to 100 feet per minute. It was discovered that low viscosity polycarbonate resin processed under the above conditions gives rise to low residual stress and low birefringence. Therefore low birefringence film can be obtained from extrusion using any molecular weight polycarbonate resin from high molecular weight to low molecular weight resin (about 30,000 weight average to less than about 18,000 weight average) under certain processing conditions. This was discovered that control of viscosity under processing conditions is the key to low stress film. The process is not limited to low molecular weight resin for low stress film but medium or high molecular weight can also be used as long as low viscosity under the processing conditions set forth above can be achieved to obtain low stress extruded film.

For optical media application, low birefringence is required in order to reduce attenuation of laser realert signal. The currently existing polish/polish film, however, have relatively high birefringence (500 nm), and, therefore, not suitable for data storage application. With the instant invention, low stress film can be made using a variety range of polycarbonate molecular weights under proper process conditions as described above. The invention offers a new way of using existing calendering rolls to make low birefringence film suitable for use in optical media applications.

### SUMMARY OF THE INVENTION

One feature of the invention relates to process for making a polycarbonate film, and a polycarbonate film having a low birefringence of 50 nm or less for use in optical media applications. Polycarbonates having a molecular weight of 30,000 weight average or less and preferably 25,000 or less and particularly 13,000-25,000 molecular weight are most desirable for optical media applications since they have a shorter relaxation time and therefore lower stress and lower birefringence under the same processing conditions.

Another feature of the process of the instant invention relates to a polycarbonate film having a birefringence of 50 nm or less, wherein said polycarbonate is a low viscosity polycarbonate resin.

### DETAILED DESCRIPTION OF THE INVENTION

The present invention discloses a process and a product prepared by the process, namely; a polycarbonate film for optical media applications wherein the film has low stress and low birefringence of 50 nm or less. For extruded film, the residual stress is mostly related to the shear stress during processing (e.g. high shear during calendering). The stress is the product of melt viscosity and shear rate. Under certain conditions such as the same nip or gap or film thickness, the stress is directly related to the melt viscosity under certain processing conditions. The polycarbonate viscosity can be controlled by the molecular weight of the polycarbonate resin and/or processing temperature and rate of extrusion. To achieve the same viscosity, higher temperature is needed for high molecular weight polycarbonate than for low molecular weight polycarbonate. Therefore, a wide range of molecular weight polycarbonate resins can be used to make low birefringence film as long as the melt viscosity is low enough under the processing conditions of this invention. The low viscosity of the resin melt leads to quicker stress relaxation and therefore less residual stress and low birefringence. While high molecular weight (weight average) can be employed herein, low and medium molecular weight polycarbonate resins are preferred to avoid too high an extrusion temperature which may cause degradation of the resin.

The melt viscosity should be less than about 300 Pascal and preferably about 100 to about 275 Pascal. To achieve a melt viscosity of less than about 300 Pascal with high molecular weight polycarbonate resins, an extrusion temperature of at least 340° C. and preferably about 340° C. to about 360° C. should be employed to achieve a melt viscosity of less than 400 Pascal. With lower molecular weight polycarbonate resins, lower extrusion temperatures may be employed, i.e. extrusion temperatures of about 275 to about 285° C. may be employed. At melt viscosities set forth above, films having a retardation value of 50 nm or less can be obtained at film thicknesses of about 100 μm to about 600 μm under processing conditions described above.

The polycarbonate resin is an aromatic carbonate homopolymer made up of recurring aryl polycarbonate units of the formula:

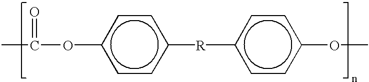

wherein R is a divalent hydrocarbon radical containing from 1-15 carbon atoms and n is an integer of from about 20 to about 150. The polycarbonate is obtained by the reaction of an aromatic dihydroxy compound with a carbonate precursor such as a carbonyl chloride or a daryl carbonate or the like. A preferred aromatic dihydroxy compound is 2,2-bis(4-hydroxy phenyl)propane also commonly known as Bisphenol-A.

### EXAMPLES

The following Examples are provided merely to show one skilled in the art how to apply the principals of this invention as discussed herein. The Examples are not intended to limit the scope of the claims appended to this invention.

Extrusion trials were conducted on a horizontal first nip roll stack producing film having a thickness about 200 μm and extruded at a rate of about 40 feet/minute. The temperature of the rolls in the roll stack was at about 115° C. The results obtained for two different molecular weight polycarbonate (weight average molecular weight) and at various extrusion temperatures are reported in Table I below showing the various birefringence obtained as well.

TABLE I

| Polycarbonate | Extrusion | Birefringence | |
|---|---|---|---|
| Molecular Wt. | Temperature ° C. | (μm) | Viscosity |
| 18,000 | 247 | 128 | 400 |
| | 254 | 85 | 300 |
| | 265 | 77 | 175 |
| | 274 | 45 | 100 |
| | 282 | 51 | 125 |
| 30,000 | 308 | 130 | 650 |
| | 313 | 103 | 600 |
| | 322 | 85 | 450 |
| | 331 | 73 | 475 |
| | 340 | 50 | 275 |

Although the present invention has been described in detail, it should be understood that various modifications, substitutions, or alternatives can be made without departing from the intended scope as defined in the appended claims.

What is claimed is:

1. A process for producing a continuous aromatic homo-polycarbonate resin film having a low birefringence of about 50 nm or less and a low stress wherein the process comprises extruding a polycarbonate resin film at an extrusion temperature of about 275° C. to about 360° C., and at a rate of about 10 to about 100 feet per minute, advancing the melted polymer film into a gap between two calendering rolls wherein the calendaring rolls are at a temperature below the glass transition temperature of the polycarbonate resin, advancing the melted polycarbonate resin film through said gap and cooling the polycarbonate resin film, said extruded polycarbonate resin having a melt viscosity of about 100 to about 275 Pascal and a weight average molecular weight of about 30,000 or less.

2. The process of claim 1 wherein the polycarbonate resin has a weight average molecular weight of about 13,000 to about 25,000.

3. The process of claim 1 wherein the polycarbonate resin film has a thickness of about 100 to about 600 μm.

4. The process of claim 1 wherein the polycarbonate resin has a weight average molecular weight of about 18,000 to about 30,000.

5. A polycarbonate resin film having a birefringence of 50 nm or less and low stress prepared by the process of claim 1.

6. A polycarbonate resin film suitable for optical media applications prepared by the process of claim 1.

7. A polycarbonate resin film having a birefringence of 50 nm or less and low stress prepared by the process of claim 4.
